(19) United States
(12) Patent Application Publication
(10) Pub. No.: US 2023/0066791 A1
(43) Pub. Date: Mar. 2, 2023

(54) ENTERPRISE-ORIENTED CONTACT RECOMMENDATIONS

(71) Applicant: Citrix Systems, Inc., Ft. Lauderdale, FL (US)

(72) Inventors: Peng Yao, Nanjing (CN); Tianyu Xiao, Nanjing (CN)

(73) Assignee: Citrix Systems, Inc., Ft. Lauderdale, FL (US)

(21) Appl. No.: 17/448,383

(22) Filed: Sep. 22, 2021

Related U.S. Application Data
(63) Continuation of application No. PCT/CN2021/114680, filed on Aug. 26, 2021.

(51) Int. Cl. H04L 29/08; G06Q 10/10; G06F 16/245

(52) U.S. Cl. CPC H04L 67/36; G06Q 10/101; G06F 16/245; H04L 67/22; G06Q 10/103; G06Q 10/105

(57) ABSTRACT

A computing device configured to provide personal contact recommendations to a user of a messaging application is provided. The computing device includes a memory, a user interface, and at least one processor coupled to the memory and the user interface. The at least one processor is configured to monitor interactions between the user and the messaging application during a messaging session, determine one or more additional participants in the messaging session, determine a plurality of closeness values based upon the user and the one or more additional participants in the messaging session, determine one or more recommended contacts for the user based upon the plurality of closeness values, and display, on the user interface, an identifier of at least one of the one or more recommended contacts to the user during the messaging session.

### CROSS-REFERENCE TO RELATED APPLICATION

This application claims the benefit under 35 U.S.C. § 120 as a continuation of PCT Application No. PCT/CN2021/114680, titled “ENTERPRISE-ORIENTED CONTACT RECOMMENDATIONS,” filed on Aug. 26, 2021, which designates the United States. The aforementioned application is hereby incorporated herein by reference in its entirety.

### BACKGROUND

In modern work environments, employees typically work with different people in different teams to achieve cooperative success. Communication applications, such as messaging or chat applications, play an important role in cooperation and collaboration. As the scale of different people and different teams becomes larger, locating a person that an employee wants to or should contact using, for example, a messaging application becomes a common challenge. For example, an employee may recall they previously contacted a specific person to ask a particular question. However, as time passes, records of the previous communications with that specific person may be lost or otherwise difficult to locate in historical saved data.

### SUMMARY

In at least one example, a computing device configured to provide personal contact recommendations to a user of a messaging application is provided. The computing device includes a memory, a user interface, and at least one processor coupled to the memory and the user interface. The at least one processor is configured to monitor interactions between the user and the messaging application during a messaging session, determine one or more additional participants in the messaging session, determine a plurality of closeness values based upon the user and the one or more additional participants in the messaging session, determine one or more recommended contacts for the user based upon the plurality of closeness values, and display, on the user interface, an identifier of at least one of the one or more recommended contacts to the user during the messaging session.

Implementations of the computing device configured to provide personal contact recommendations to a user of a messaging application can include one or more of the following features.

In examples of the computing device, the at least one processor can be configured to determine the plurality of closeness values comprises the processor being further configured to determine one or more user groups to which the user and the one or more additional participants belong, determine one or more relationship data structures for the one or more user groups, the one or more relationship data structures comprising a listing of a plurality of contacts and the plurality of closeness values such that each pair of contacts has an associated closeness value, and identify the associated closeness value for each pair of contacts in the plurality of contacts. In some examples, the one or more relationship data structures includes a plurality of relationship diagrams, and the at least one processor can be further configured to identify two or more relationship data structures within the plurality of relationship diagrams that correspond to the user and the one or more additional participants, identify a plurality of corresponding closeness values within the two or more relationship data structures, calculate a set of total closeness values for each pair of contacts within the two or more relationship data structures by summing the identified plurality of corresponding closeness values, and generate an overall recommendation diagram based upon the set of total closeness values. In some examples, the at least one processor can be further configured to determine the one or more recommended contacts for the user based upon the overall recommendation diagram. In some examples, at least one of the one or more recommended contacts for the user is not a member of the one or more user groups.

In examples of the computing device, the at least one processor can be further configured to determine one or more user groups to which the user is a member, determine historic messaging session information for each of the one or more user groups, and determine the plurality of closeness values based upon the historic messaging session information. In some examples, the at least one processor can be further configured to monitor for changes to the one or more user groups and/or the historic messaging session information and update the plurality of closeness values based upon changes to the one or more user groups and/or the historic messaging session information. In some examples, the at least one processor can be further configured to determine when a first member of the one or more user groups mentions a second contact name in the historic messaging information and increment a closeness value between the first member and the second contact based upon the determined mention. In some examples, the second contact is not a member of the one or more user groups.

In another example, a method for providing personal contact recommendations to a user of a messaging application is provided. The method includes monitoring, by at least one processor, interactions between the user and the messaging application during a messaging session; determining, by the at least one processor, one or more additional participants in the messaging session; determining, by the at least one processor, a plurality of closeness values based upon the user and the one or more additional participants in the messaging session; determining, by the at least one processor, one or more recommended contacts for the user based upon the plurality of closeness values; and displaying, by the at least one processor on a user interface, an identifier of at least one of the one or more recommended contacts to the user during the messaging session.

Implementations of the method for providing personal contact recommendations to a user of a messaging application can include one or more of the following features.

In examples of the method, determining the plurality of closeness values can include determining, by the at least one processor, one or more user groups to which the user and the one or more additional participants belong; determining, by the at least one processor, one or more relationship data structures for the one or more user groups, the one or more relationship data structures comprising a listing of a plurality of contacts and the plurality of closeness values such that each pair of contacts has an associated closeness value; and identifying, by the at least one processor, the associated closeness value for each pair of contacts in the plurality of contacts. In some examples, the one or more relationship data structures can include a plurality of relationship diagrams, and the method further includes identifying, by the at least one processor, two or more relationship data structures within the plurality of relationship diagrams that correspond to the user and the one or more additional participants; identifying, by the at least one processor, a plurality of corresponding closeness values within the two or more relationship data structures; calculating, by the at least one processor, a set of total closeness values for each pair of contacts within the two or more relationship data structures by summing the identified plurality of corresponding closeness values; and generating, by the at least one processor, an overall recommendation diagram based upon the set of total closeness values. In some examples, the method can further include determining, by the at least one processor, the one or more recommended contacts for the user based upon the overall recommendation diagram. In some examples, at least one of the one or more recommended contacts for the user is not a member of the one or more user groups.

In examples of the method, the method can further include determining, by the at least one processor, one or more user groups to which the user is a member; determining, by the at least one processor, historic messaging session information for each of the one or more user groups; and determining, by the at least one processor, the plurality of closeness values based upon the historic messaging session information. In some examples, the method can include monitoring, by the at least one processor, for changes to the one or more user groups and/or the historic messaging session information and updating, by the at least one processor, the plurality of closeness values based upon changes to the one or more user groups and/or the historic messaging session information.

In some examples, the method can include determining, by the at least one processor, when a first member of the one or more user groups mentions a second contact name in the historic messaging information and incrementing, by the at least one processor, a closeness value between the first member and the second contact based upon the determined mention. In some examples. the second contact is not a member of the one or more user groups.

In another example, a non-transitory computer-readable medium storing computer-executable instructions to provide personal contact recommendations to a user of a messaging application is provided. The instructions comprising instructions to monitor interactions between the user and the messaging application during a messaging session, determine one or more additional participants in the messaging session, determine a plurality of closeness values based upon the user and the one or more additional participants in the messaging session, determine one or more recommended contacts for the user based upon the plurality of closeness values, and display, on a user interface operably coupled to the non-transitory computer readable medium, an identifier of at least one of the one or more recommended contacts to the user during the messaging session.

Implementations of the non-transitory computer-readable medium storing computer-executable instructions to provide personal contact recommendations to a user of a messaging application can include one or more of the following features.

In examples of the non-transitory computer-readable medium, the instructions can further include instructions to determine one or more user groups to which the user and the one or more additional participants belong, determine one or more relationship data structures for the one or more user groups, the one or more relationship data structures comprising a listing of a plurality of contacts and the plurality of closeness values such that each pair of contacts has an associated closeness value, and identify the associated closeness value for each pair of contacts in the plurality of contacts. In some examples, the one or more relationship data structures can include a plurality of relationship diagrams, and the instructions further can include instructions to identify two or more relationship data structures within the plurality of relationship diagrams that correspond to the user and the one or more additional participants, identify a plurality of corresponding closeness values within the two or more relationship data structures, calculate a set of total closeness values for each pair of contacts within the two or more relationship data structures by summing the identified plurality of corresponding closeness values, and generate an overall recommendation diagram based upon the set of total closeness values. In some examples, the instructions can further include instructions to determine the one or more recommended contacts for the user based upon the overall recommendation diagram. In some examples, at least one of the one or more recommended contacts for the user is not a member of the one or more user groups.

In examples of the non-transitory computer-readable medium, the instructions can further include instructions to determine one or more user groups to which the user is a member, determine historic messaging session information for each of the one or more user groups, and determine the plurality of closeness values based upon the historic messaging session information. In some examples, the instructions can further include instructions to monitor for changes to the one or more user groups and/or the historic messaging session information and update the plurality of closeness values based upon changes to the one or more user groups and/or the historic messaging session information. In some examples, the instructions can further include instructions to determine when a first member of the one or more user groups mentions a second contact name in the historic messaging information and increment a closeness value between the first member and the second contact based upon the determined mention. In some examples, the second contact is not a member of the one or more user groups.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, each identical or nearly identical component that is illustrated in various figures is represented by a like numeral. For purposes of clarity, not every component may be labeled in every figure.

FIG. 1 is a block diagram of a system architecture for accessing a distributed workspace by multiple client devices.

FIG. 2 is a block diagram of a state manager for a messaging application system in accordance with an example of the present disclosure.

FIG. 3 is a block diagram of a sample network environment of computing devices in which various aspects of the present disclosure can be implemented.

FIG. 4 is a block diagram of a cloud computing environment in which various aspects of the present disclosure can be implemented.

FIGS. 5A-5C are block diagrams of sample systems in which resource management services can manage and streamline client access to resource feeds, in accordance with an example of the present disclosure.

FIG. 6 is a screenshot of a messaging application, in accordance with an example of the present disclosure.

FIG. 7 is a flow diagram for generating contact relationship diagrams including associated closeness values, in accordance with an example of the present disclosure.

FIGS. 8A-8C illustrate contact relationship diagrams for a first group of contacts, in accordance with an example of the present disclosure.

FIGS. 9A-9C illustrate contact relationship diagrams for a second group of contacts, in accordance with an example of the present disclosure.

FIGS. 10A-10C illustrate contact relationship diagrams for a third group of contacts, in accordance with an example of the present disclosure.

FIG. 11 is a flow diagram for determining updated contact recommendations for a user of a messaging application, in accordance with an example of the present disclosure.

FIGS. 12A-12C illustrate contact recommendation diagrams for a user of a messaging application, in accordance with an example of the present disclosure.

FIG. 13 is a screenshot of a messaging application including updated contact recommendation information, in accordance with an example of the present disclosure.

FIG. 14 is a block diagram of one or more of the computing devices as described herein, in accordance with at least one example of the present disclosure.

### DETAILED DESCRIPTION

As summarized above, various examples described herein are directed to systems and methods for providing contact recommendations to a user of a messaging application. For example, the systems and methods as described herein monitor messaging application activity for a user and, based upon who the user is communicating with, can provide the user with dynamic and updated contact recommendations.

Some messaging and/or chat applications include a contact recommendation system. However, this recommendation is generally pulled from a list of a user's contacts or is based upon how regularly the user interacts with a particular contact. If the user messages with a particular contact regularly, that contact is likely to be highly ranked as a recommended contact for the user within the application. However, it can be beneficial for a user to receive one or more additional contacts that are outside their normal set of regular contacts or coworkers. For example, if a user interacts regularly with a particular coworker, it may be beneficial to recommend one or more additional contacts that the coworker regularly interacts with to the user. In such an example, the user may benefit from an expanded set of contacts and, by association, an expanded knowledge base from which to find solutions to problems or to discuss work projects or other related topics.

Additionally, a user may have connected with a particular contact in the past and may want to reconnect. However, the user may have difficulty remembering the contacts name or contact information. By regularly analyzing the messaging activity of the user's regular contacts (e.g., once a day or after the conclusion of each messaging or chat session), as well as historic messaging information for the user and their associated contacts, information about the past contact may be determined and the past contact can be recommended to the user to reconnect.

The systems and methods as described herein overcome the disadvantages and limitations of traditional contact recommendation systems as included in messaging applications by analyzing both group communications involving a user as well as historical group communication information involving the user. Such systems and methods as described herein provide various advantages to improve contact recommendations and overall user experience with those recommendations. For example, by analyzing group information as well as historic information, contacts outside the user's group that the user may not otherwise interact with can be recommended to the user as well as contacts the user has interacted with in the past that they may not remember the contact information for. By providing such expanded contact recommendations, the systems and methods as described herein can provide a more robust and personalized contact recommendation system to an individual user as compared to existing contact recommendation systems.

Thus, and in accordance with at least some examples disclosed herein, systems and methods for determining personalized recommended contacts are provided. These systems and methods enhance the overall benefit of the contact recommendation system to a user, as well as the user's overall experience with a messaging application, by providing personalized and historically analyzed contact recommendations to the user for the user's consideration and potential interaction with the recommended contacts.

In some examples, a computing device for providing personalized contact recommendation to a user of at least one messaging application is provided. The computing device includes a computer readable medium and at least one processor operably coupled to the computer readable medium. The at least one processor can be configured to monitor messaging application activity for a user for a new messaging session and determine one or more additional participants in the new messaging session. Based upon the participants in the messaging session, the at least one processor can determine one or more user groups to which the user and the one or more additional participants belong. For example, the one or more user groups can be based upon an organizational structure such that members or a project team or people having the same manager are members of the same group. The at least one processor can further determine one or more relationship diagrams for the one or more user groups, the one or more relationship diagrams including a structured listing of contacts associated with the one or more groups and a set of closeness values such that each pair of contacts has an associated closeness value. The closeness values can be represented as a numerical value and provide an indication of how often the pair of contacts refers to one another in historic messaging information. The at least one processor can further determine one or more recommended contacts for the user based upon the set of closeness values and present the one or more recommended contacts for the user within the new messaging session.

Examples of the methods, systems, and processes discussed herein are not limited in application to the details of construction and the arrangement of components set forth in the following description or illustrated in the accompanying drawings. The methods and systems are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

### Sample Computing Systems

In some examples, a distributed system is configured to implement workspace and system access to remote users, thereby providing a central repository of applications, files, and other similar resources to a group of trusted users accessible via, for example, an enterprise service. A distributed workspace can be implemented as a software framework designed to deliver and manage a user's applications, data, and desktops in a consistent and secure manner, regardless of the user's device or location. Distributed workspaces enhance the user experience by streamlining and automating those tasks that a user performs frequently, such as approving expense reports, confirming calendar appointments, submitting helpdesk tickets, and reviewing vacation requests. A distributed workspace allows users to access functionality provided by multiple enterprise applications—including software as a system (SaaS) applications, web applications, desktop applications, and proprietary applications—through a single interface.

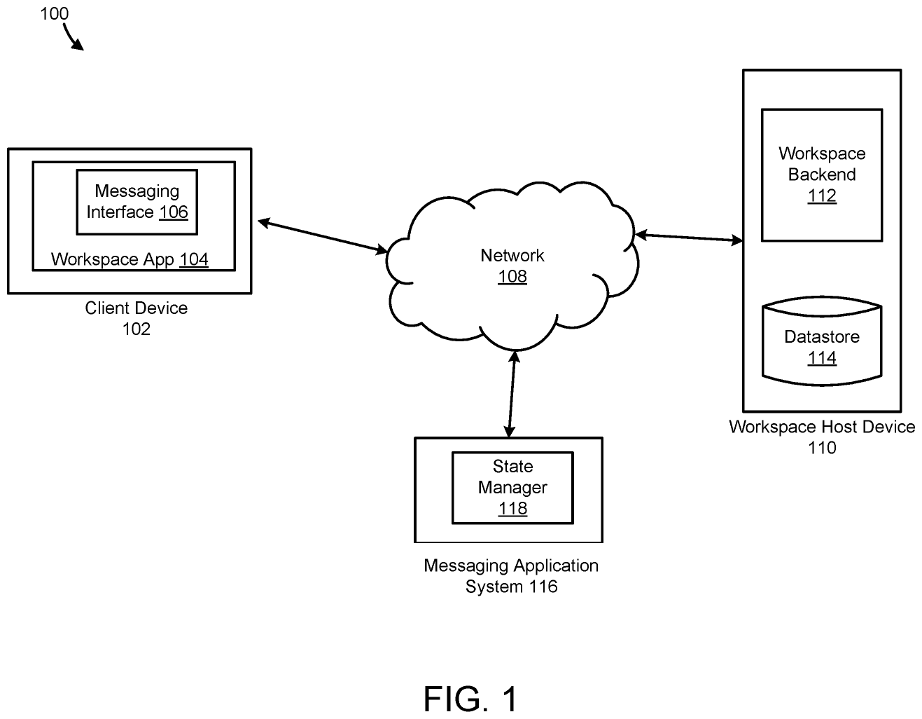

FIG. 1 illustrates a logical architecture of one implementation of a distributed workspace system 100 that is configured to connect one or more client computing devices with one or more remote computing devices configured to host shared resources such as applications accessible via the distributed workspace. As shown in FIG. 1, the system 100 can include a client device 102. As further shown in FIG. 1, client devices 102 can include a workspace application 104. The workspace application 104 can be configured to provide an interface to facilitate remote access to one or more resources hosted at or by, for example, a remote computing device such as workspace host device 110. In certain implementations, the client device 102 can be operably connected to the remote computing device via one or more networks 108. In some examples, the network 108 can be a wired network, a wireless network, or a combination of both wired and wireless networks.

In some examples, the workspace host device 110 can execute, operate, or otherwise provide an application that can be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft Internet Protocol telephone; an application for streaming video and/or audio; an application for facilitating real-time-data communications; a HyperText Transfer Protocol (HTTP) client; a File Transfer Protocol (FTP) client; an Oscar client; a Telnet client; or any other set of executable instructions.

In some examples, the workspace host device 110 can execute a remote presentation services program or other program that uses a thin client or a remote-display protocol to capture display output generated by an application executing on the remote computing device. The remote computing device 110 can further transmit the application display output to the client device 102 for presentation to one or more device users.

In some examples, the workspace host device 110 can include a server agent that is configured to communicate with the workspace application 104. The server agent can be configured to, for example, authenticate a client device and provide secure access to one or more remote and/or shared resources. The server agent can further monitor user interactions with the resources, update user access based upon changes to user permission levels for a client device, distribute or properly direct requests to available resources, and perform other similar distributed workspace functions.

In yet other examples, the workspace host device 110 can be configured to execute a virtual machine providing access to a computing environment to a user of client device 102. The virtual machine can be managed by, for example, a hypervisor, a virtual machine manager (VMM), or any other hardware virtualization technique within the workspace host device 110.

In some examples, the network 108 can be: a local area network (LAN); a metropolitan area network (MAN); a wide area network (WAN); a primary public network; and a primary private network. Additional examples can include a network 108 of mobile telephone networks that use various protocols to communicate among mobile devices. For short range communications within a wireless local-area network (WLAN), the protocols can include 802.11, Bluetooth, and Near Field Communication (NFC).

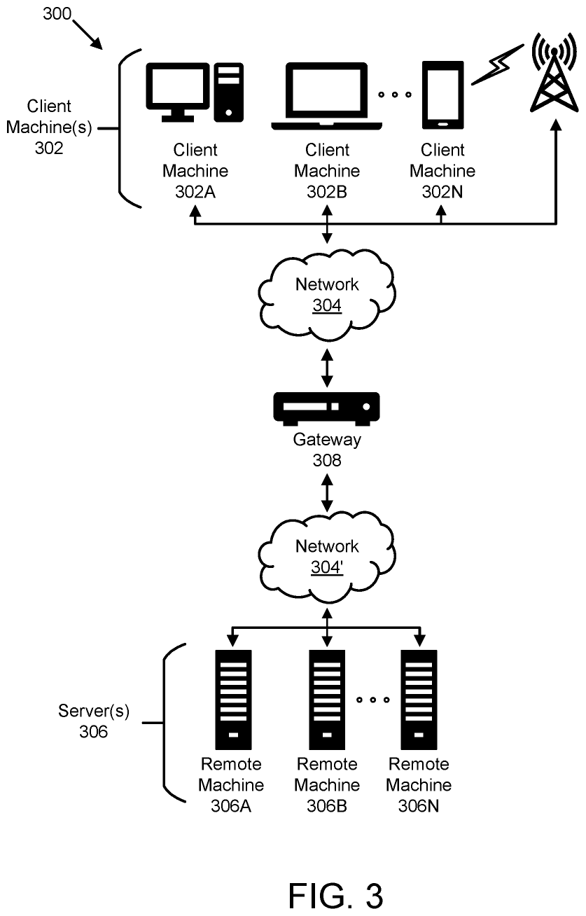

It should be noted that the specific device architecture as shown in FIG. 1 is provided by way of example only. For instance, in certain implementations, multiple remote computing devices can be operably connected to the client devices via, for example, one or more network appliances configured to perform, for example, access control and load balancing. Additional network examples and associated devices are described below in the discussion of FIG. 3.

In a typical distributed workspace, a user of the client device 102 can access a messaging application interface 106 through, for example, the workspace application 104. For example, the user can message other users of the distributed workspace system 100 using the messaging application interface 106. Messaging information and/or data can be processed by the workspace application 104 and transmitted to a workspace backend 112 on the workspace host device 110.

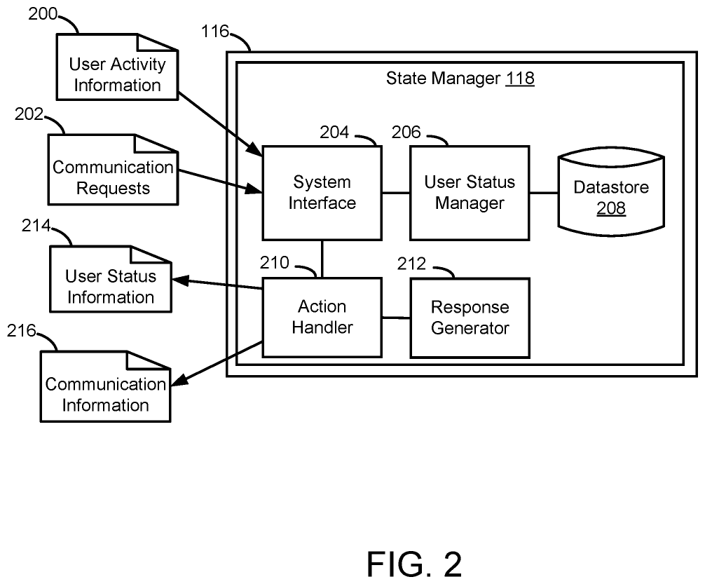

As noted above, to further process messaging application information, the distributed workspace system 100 can include a messaging application system 116. As further shown in FIG. 1, the messaging application system 116 can include state manager 118. The state manager 118 can be configured to monitor user activity at, for example, the client workstation 102 as well as process messaging application information transmitted throughout the distributed workspace system 100. FIG. 2 Illustrates a detailed view of the messaging application system 116 and the state manager 118. For example, as shown in FIG. 2, the messaging application system 116 can be configured to receive both user activity information 200 and one or more communication requests 202. The state manager 118 can includes a system interface 204 configured to receive and process incoming data such as user activity information 200 and communication requests 202. The system interface 204 can process the user activity information 200 and pass the user activity information 200 to a user status manager 206. The user status manager 206 can be configured to analyze the user activity information 200 and determine a current activity level for a user of, for example, the client workstation 102 based upon the user activity information 200.

As further shown in FIG. 2, the user status manager 206 can be operably coupled to a datastore 208. The user status manager 206 can be configured to store at least a portion of the user activity information 200 in the datastore 208 as, for example, historic user information, for later processing.

The system interface 204 can also be operably coupled to an action handler 210. The action handler 210 can be configured to receive information from the system interface 204, process the information, and generate output information for transmission to one or more devices within, for example, the distributed workspace system 100. For example, the action handler 210 can be configured to receive user status information from the system interface 204 and output the user status information to one or more devices within the distributed workspace system 100. For example, as shown in FIG. 2, the action handler 210 can be configured to output user status information 214 to one or more devices within the distributed workspace system 100. The action handler 210 can also be configured to process the communication requests 202 as received from the system interface 204. For example, the communication requests 202 can include a request to establish communications between a first device and a second device of the distributed workspace system 100. The action handler 210 can process the communication request 202, determine an action to be taken in response to the communication request 202, and execute the response action. In certain implementations, the action handler 210 can be operably coupled to a response generator 212. The response generator 212 can be configured to process information received from the action handler 210, generate an appropriate response, and provide the response to the action handler 210 for transmission to one or more devices within the distributed workspace system 100.

For example, the system interface 204 can receive a communication request 202 to establish a communication session between a first client and a second client within the distributed workspace system 100. The action handler 210 can process the received communication request 202, communicate with the response generator 212 to generate a response to the communication request 202, and output a response to the communication request 202 as, for example, communication information 216. As such, messaging application system 116 as described herein and shown in FIGS. 1 and 2 can be configured to both monitor and process user activity within one or more messaging applications as well as process communication information between computing devices within the distributed workspace system 100.

As noted above in FIG. 1, various computing devices can be arranged into one or more interconnected networks to provide user access to remote resources through various client devices. Referring to FIG. 3, a non-limiting network environment 300 provides an alternative arrangement to network 100 as shown in FIG. 1, in which various aspects of the disclosure can be implemented. As shown in FIG. 3, the environment 300 includes one or more client machines 302A-302N, one or more remote machines 306A-306N, one or more networks 304, 304′, and one or more appliances 308 installed within the computing environment 300. The client machines 302A-302N communicate with the remote machines 306A-306N via the networks 304, 304′. The computing environment 300 can also be referred to as a distributed computer system.

In some examples, the client machines 302A-302N communicate with the remote machines 306A-306N via an intermediary appliance 308. The illustrated appliance 308 is positioned between the networks 304, 304′ and can also be referred to as a network interface or gateway. In some examples, the appliance 308 can operate as remote computing device configured to provide clients with access to business applications and other data deployed in a datacenter, the cloud, or delivered as SaaS applications across a range of client devices, and/or provide other functionality such as load balancing, etc. In some examples, multiple appliances 308 can be used, and the appliance(s) 308 can be deployed as part of the network 304 and/or 304′.

The client machines 302A-302N can be generally referred to as client machines 302, local machines 302, clients 302, client nodes 302, client computers 302, client devices 302, computing devices 302, endpoints 302, or endpoint nodes 302. In certain implementations, client machines 302 can include, for example, client device 102 as shown in FIG. 1 and described above.

The remote machines 306A-306N can be generally referred to as servers 306 or a server farm 306. In some examples, a client device 302 can have the capacity to function as both a client node seeking access to resources provided by a server 306 and as a server 306 providing access to hosted resources for other client devices 302A-302N. The networks 304, 304′ can be generally referred to as a network 304. The networks 304 can be configured in any combination of wired and wireless networks.

A server 306 can be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality. In some examples, a server 306 can include the functionality of the workspace host device 110 as shown in FIG. 1 and described above.

A server 306 can execute, operate, or otherwise provide an application that can be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft Internet Protocol telephone; an application for streaming video and/or audio; an application for facilitating real-time-data communications; a HyperText Transfer Protocol client; a File Transfer Protocol client; an Oscar client; a Telnet client; or any other set of executable instructions.

In some examples, a server 306 can execute a remote presentation services program or other program that uses a thin client or a remote-display protocol to capture display output generated by an application executing on a server 306 and transmit the application display output to a client device 302.

In yet other examples, a server 306 can execute a virtual machine providing, to a user of a client device 302, access to a computing environment. The client device 302 can be a virtual machine. The virtual machine can be managed by, for example, a hypervisor, a virtual machine manager (VMM), or any other hardware virtualization technique within the server 306.

In some examples, the network 304 can be: a LAN; a MAN; a WAN; a primary public network; and a primary private network. Additional examples can include a network 304 of mobile telephone networks that use various protocols to communicate among mobile devices. For short range communications within a WLAN, the protocols can include 802.11, Bluetooth, and NFC. In certain examples, the network 304 can include network 108 as shown in FIG. 1 and described above.

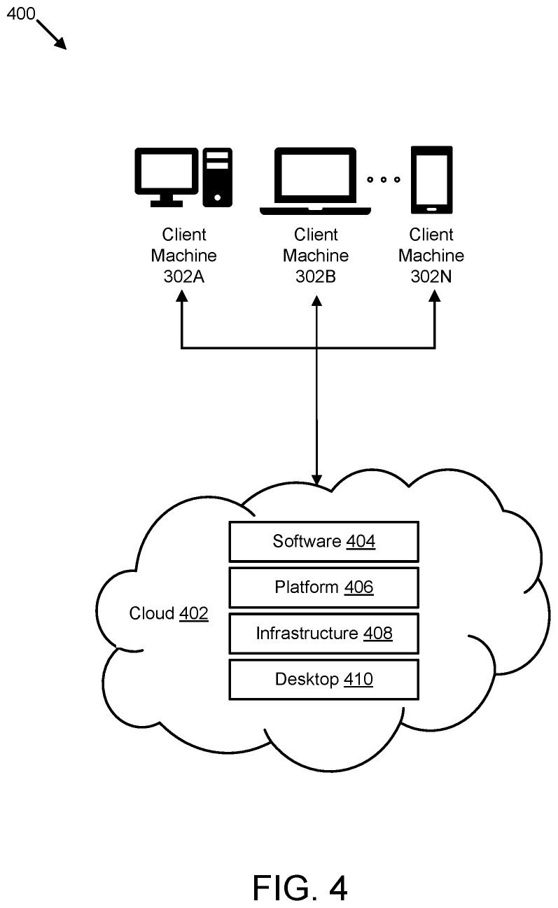

Referring to FIG. 4, a cloud computing environment 400 is depicted, which can also be referred to as a cloud environment, cloud computing platform, or cloud network. The cloud computing environment 400 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and other processes.

In the cloud computing environment 400, one or more clients 302a-302n (such as those described above and shown in FIG. 3) are in communication with a cloud network 402. The cloud network 402 can include back-end platforms, e.g., servers, storage, server farms or data centers. The users or clients 302a-302n can correspond to a single organization/tenant or multiple organizations/tenants. More particularly, in one example implementation the cloud computing environment 400 can provide a private cloud serving a single organization (e.g., enterprise cloud). In another example, the cloud computing environment 400 can provide a community or public cloud serving multiple organizations/tenants.

In some examples, a gateway appliance(s) or service can be utilized to provide access to cloud computing resources and virtual sessions. By way of example, Citrix Gateway, provided by Citrix Systems, Inc., can be deployed on-premises or on public clouds to provide users with secure access and single sign-on to virtual, SaaS and web applications. Furthermore, to protect users from web threats, a gateway such as Citrix Secure Web Gateway can be used. Citrix Secure Web Gateway uses a cloud-based service and a local cache to check for uniform resource locator (URL) reputation and category.

In still further examples, the cloud computing environment 400 can provide a hybrid cloud that is a combination of a public cloud and a private cloud. Public clouds can include public servers that are maintained by third parties to the clients 302a-302n or the enterprise/tenant. The servers can be located off-site in remote geographic locations or otherwise.

The cloud computing environment 400 can provide resource pooling to serve multiple users via clients 302a-302n through a multi-tenant environment or multi-tenant model with different physical and virtual resources dynamically assigned and reassigned responsive to different demands within the respective environments. The multi-tenant environment can include a system or architecture that can provide a single instance of software, an application or a software application to serve multiple users. In some implementations, the cloud computing environment 400 can provide on-demand self-service to unilaterally provision computing capabilities (e.g., server time, network storage) across a network for multiple clients 302a-302n. By way of example, provisioning services can be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 400 can provide an elasticity to dynamically scale out or scale in response to different demands from one or more clients 302. In some examples, the cloud computing environment 400 can include or provide monitoring services to monitor, control and/or generate reports corresponding to the provided shared services and resources.

In some implementations, the cloud computing environment 400 can provide cloud-based delivery of different types of cloud computing services, such as SaaS 404, Platform as a Service (PaaS) 406, Infrastructure as a Service (IaaS) 408, and Desktop as a Service (DaaS) 410, for example. IaaS can refer to a user renting the use of infrastructure resources that are needed during a specified time period. IaaS providers can offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers can offer functionality provided by IaaS, including, e.g., storage, networking, servers or virtualization, as well as additional resources such as, e.g., operating system, middleware, or runtime resources. Examples of PaaS include WINDOWS AZURE CLOUD provided by Microsoft Corporation of Redmond, Wash. (herein “Azure”), Google App Engine provided by Google Inc., and HEROKU provided by Heroku, Inc. of San Francisco, Calif.

SaaS providers can offer the resources that PaaS provides, including storage, networking, servers, virtualization, operating system, middleware, or runtime resources. In some examples, SaaS providers can offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS can also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms can be hosted on a public cloud computing infrastructure such as Azure, or AMAZON WEB SERVICES provided by Amazon.com, Inc., of Seattle, Wash. (herein “AWS”), for example. In the case of Citrix Cloud, Citrix Workspace application can be used as a single-entry point for bringing apps, files and desktops together (whether on-premises or in the cloud) to deliver a unified experience.

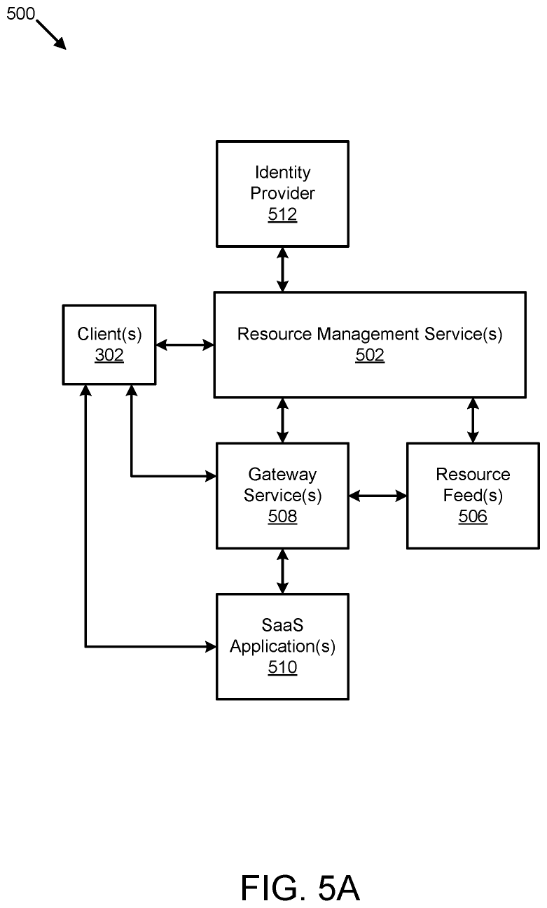

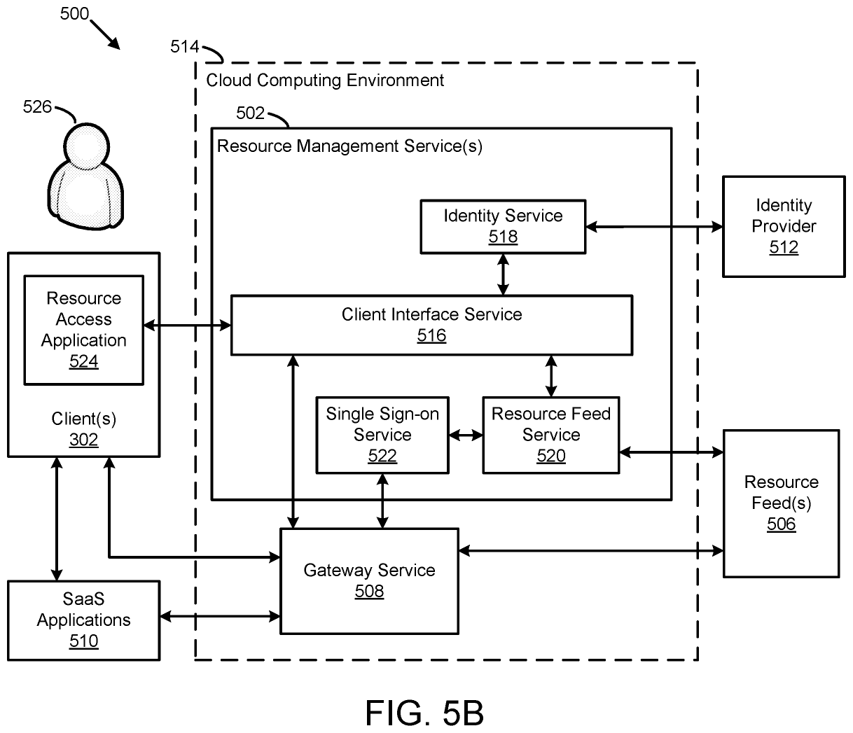

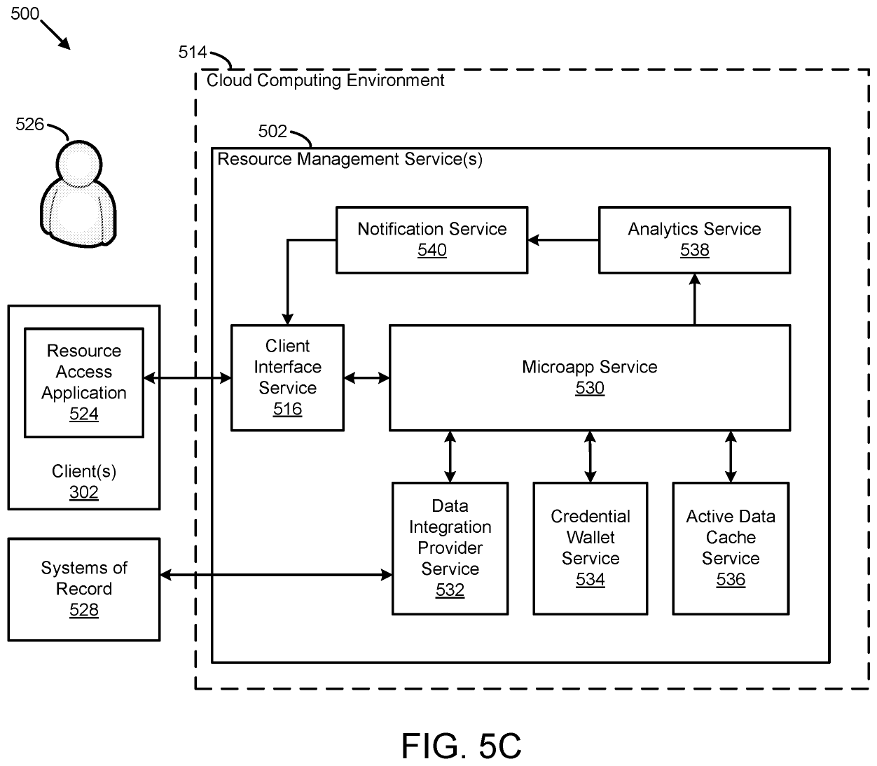

FIG. 5A is a block diagram of an example system 500 in which one or more resource management services 502 can manage and streamline access by one or more clients 302 to one or more resource feeds 506 (via one or more gateway services 508) and/or one or more SaaS applications 510. In particular, the resource management service(s) 502 can employ an identity provider 512 to authenticate the identity of a user of a client 302 and, following authentication, identify one or more resources the user is authorized to access. In response to the user selecting one of the identified resources, the resource management service(s) 502 can send appropriate access credentials to the requesting client 302, and the client 302 can then use those credentials to access the selected resource. For the resource feed(s) 506, the client 302 can use the supplied credentials to access the selected resource via a gateway service 508. For the SaaS application(s) 510, the client 302 can use the credentials to access the selected application directly.

The client(s) 302 can be any type of computing devices capable of accessing the resource feed(s) 506 and/or the SaaS application(s) 510, and can, for example, include a variety of desktop or laptop computers, smartphones, tablets, etc. The resource feed(s) 506 can include any of numerous resource types and can be provided from any of numerous locations. In some implementations, for example, the resource feed(s) 506 can include one or more systems or services for providing virtual applications and/or desktops to the client(s) 302, one or more file repositories and/or file sharing systems, one or more secure browser services, one or more access control services for the SaaS applications 510, one or more management services for local applications on the client(s) 302, one or more internet enabled devices or sensors, etc. Each of the resource management service(s) 502, the resource feed(s) 506, the gateway service(s) 508, the SaaS application(s) 510, and the identity provider 512 can be located within an on-premises data center of an organization for which the system 500 is deployed, within one or more cloud computing environments, or elsewhere.

FIG. 5B is a block diagram showing an example implementation of the system 500 shown in FIG. 5A in which various resource management services 502 as well as a gateway service 508 are located within a cloud computing environment 514. The cloud computing environment can, for example, include Microsoft Azure Cloud, Amazon Web Services, Google Cloud, or IBM Cloud.

For any of illustrated components (other than the client 302) that are not based within the cloud computing environment 514, cloud connectors (not shown in FIG. 5B) can be used to interface those components with the cloud computing environment 514. Such cloud connectors can, for example, run on Windows Server instances hosted in resource locations and can create a reverse proxy to route traffic between the site(s) and the cloud computing environment 514. In the illustrated example, the cloud-based resource management services 502 include a client interface service 516, an identity service 518, a resource feed service 520, and a single sign-on service 522. As shown, in some examples, the client 302 can use a resource access application 524 to communicate with the client interface service 516 as well as to present a user interface on the client 302 that a user 526 can operate to access the resource feed(s) 506 and/or the SaaS application(s) 510. The resource access application 524 can either be installed on the client 302, or can be executed by the client interface service 516 (or elsewhere in the system 500), and accessed using a web browser (not shown in FIG. 5B) on the client 302.

As explained in more detail below, in some examples, the resource access application 524 (e.g., the workspace application 104 as shown in FIG. 1 and described above) and associated components can provide the user 526 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data. For example, as described herein, the resource application 524 can include some or all of the functionality of the messaging application system 116 and/or the state manager 118 as shown in FIG. 1 and described above.

When the resource access application 524 is launched or otherwise accessed by the user 526, the client interface service 516 can send a sign-on request to the identity service 518. In some implementations, the identity provider 512 can be located on the premises of the organization for which the system 500 is deployed. The identity provider 512 can, for example, correspond to an on-premises Windows Active Directory built or otherwise organized, for example, based upon an organizational hierarchal or directory for a company, office, project team, or other similar grouping of users and/or administrators. In such examples, the identity provider 512 can be connected to the cloud-based identity service 518 using a cloud connector (not shown in FIG. 5B), as described above. Upon receiving a sign-on request, the identity service 518 can cause the resource access application 524 (via the client interface service 516) to prompt the user 526 for the user's authentication credentials (e.g., user-name and password). Upon receiving the user's authentication credentials, the client interface service 516 can pass the credentials along to the identity service 518, and the identity service 518 can, in turn, forward them to the identity provider 512 for authentication, for example, by comparing them against an Active Directory domain. Once the identity service 518 receives confirmation from the identity provider 512 that the user's identity has been properly authenticated, the client interface service 516 can send a request to the resource feed service 520 for a list of subscribed resources for the user 526.

In other examples (not illustrated in FIG. 5B), the identity provider 512 can be a cloud-based identity service, such as a Microsoft Azure Active Directory. In such implementations, upon receiving a sign-on request from the client interface service 516, the identity service 518 can, via the client interface service 516, cause the client 302 to be redirected to the cloud-based identity service to complete an authentication process. The cloud-based identity service can then cause the client 302 to prompt the user 526 to enter the user's authentication credentials. Upon determining the user's identity has been properly authenticated, the cloud-based identity service can send a message to the resource access application 524 indicating the authentication attempt was successful, and the resource access application 524 can then inform the client interface service 516 of the successful authentication. Once the identity service 518 receives confirmation from the client interface service 516 that the user's identity has been properly authenticated, the client interface service 516 can send a request to the resource feed service 520 for a list of subscribed resources for the user 526.

For each configured resource feed, the resource feed service 520 can request an identity token from the single sign-on service 522. The resource feed service 520 can then pass the feed-specific identity tokens it receives to the points of authentication for the respective resource feeds 506. Each resource feed 506 can then respond with a list of resources configured for the respective identity. The resource feed service 520 can then aggregate all items from the different feeds and forward them to the client interface service 516, which can cause the resource access application 524 to present a list of available resources on a user interface of the client 302. The list of available resources can, for example, be presented on the user interface of the client 302 as a set of selectable icons or other elements corresponding to accessible resources. The resources so identified can, for example, include one or more virtual applications and/or desktops (e.g., Citrix Virtual Apps and Desktops™, VMware Horizon, Microsoft RDS, etc.), one or more file repositories and/or file sharing systems (e.g., Sharefile® file sharing service, one or more secure browsers, one or more internet enabled devices or sensors, one or more local applications installed on the client 302, and/or one or more SaaS applications 510 to which the user 526 has subscribed. The lists of local applications and the SaaS applications 510 can, for example, be supplied by resource feeds 506 for respective services that manage which such applications are to be made available to the user 526 via the resource access application 524. Examples of SaaS applications 510 that can be managed and accessed as described herein include Microsoft Office 365 applications, SAP SaaS applications, Workday applications, etc.

For resources other than local applications and the SaaS application(s) 510, upon the user 526 selecting one of the listed available resources, the resource access application 524 can cause the client interface service 516 to forward a request for the specified resource to the resource feed service 520. In response to receiving such a request, the resource feed service 520 can request an identity token for the corresponding feed from the single sign-on service 522. The resource feed service 520 can then pass the identity token received from the single sign-on service 522 to the client interface service 516 where a launch ticket for the resource can be generated and sent to the resource access application 524. Upon receiving the launch ticket, the resource access application 524 can initiate a secure session to the gateway service 508 and present the launch ticket. When the gateway service 508 is presented with the launch ticket, it can initiate a secure session to the appropriate resource feed and present the identity token to that feed to seamlessly authenticate the user 526. Once the session initializes, the client 302 can proceed to access the selected resource.

When the user 526 selects a local application, the resource access application 524 can cause the selected local application to launch on the client 302. When the user 526 selects a SaaS application 510, the resource access application 524 can cause the client interface service 516 request a one-time URL from the gateway service 508 as well a preferred browser for use in accessing the SaaS application 510. After the gateway service 508 returns the one-time URL and identifies the preferred browser, the client interface service 516 can pass that information along to the resource access application 524. The client 302 can then launch the identified browser and initiate a connection to the gateway service 508. The gateway service 508 can then request an assertion from the single sign-on service 522. Upon receiving the assertion, the gateway service 508 can cause the identified browser on the client 302 to be redirected to the logon page for identified SaaS application 510 and present the assertion. The SaaS can then contact the gateway service 508 to validate the assertion and authenticate the user 526. Once the user has been authenticated, communication can occur directly between the identified browser and the selected SaaS application 510, thus allowing the user 526 to use the client 302 to access the selected SaaS application 510.

In some examples, the preferred browser identified by the gateway service 508 can be a specialized browser embedded in the resource access application 524 (when the resource application is installed on the client 302) or provided by one of the resource feeds 506 (when the resource application 524 is located remotely), e.g., via a secure browser service. In such examples, the SaaS applications 510 can incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 302 such that the watermark will appear as displayed on the screen if the user tries to print or take a screenshot. Further, in some implementations, when a user selects a hyperlink within a SaaS application, the specialized browser can send the URL for the link to an access control service (e.g., implemented as one of the resource feed(s) 506) for assessment of its security risk by a web filtering service. For approved URLs, the specialized browser can be permitted to access the link. For suspicious links, however, the web filtering service can have the client interface service 516 send the link to a secure browser service, which can start a new virtual browser session with the client 302, and thus allow the user to access the potentially harmful linked content in a safe environment.

In some examples, in addition to or in lieu of providing the user 526 with a list of resources that are available to be accessed individually, as described above, the user 526 can instead be permitted to choose to access a streamlined feed of event notifications and/or available actions that can be taken with respect to events that are automatically detected with respect to one or more of the resources. This streamlined resource activity feed, which can be customized for each user 526, can allow users to monitor important activity involving all of their resources—SaaS applications, web applications, Windows applications, Linux applications, desktops, file repositories and/or file sharing systems, and other data through a single interface, without needing to switch context from one resource to another.

FIG. 5C is a block diagram similar to that shown in FIG. 5B but in which the available resources (e.g., SaaS applications, web applications, Windows applications, Linux applications, desktops, file repositories and/or file sharing systems, and other data) are represented by a single box 528 labeled “systems of record,” and further in which several different services are included within the resource management services block 502. As explained below, the services shown in FIG. 5C can enable the provision of a streamlined resource activity feed and/or notification process for a client 302. In the example shown, in addition to the client interface service 516 discussed above, the illustrated services include a microapp service 530, a data integration provider service 532, a credential wallet service 534, an active data cache service 536, an analytics service 538, and a notification service 540. In various implementations, the services shown in FIG. 5C can be employed either in addition to or instead of the different services shown in FIG. 5B.

Referring specifically to FIG. 5C, the systems of record 528 can represent the applications and/or other resources the resource management services 502 can interact with to create microapps. These resources can be SaaS applications, legacy applications, or homegrown applications, and can be hosted on-premises or within a cloud computing environment. A microapp page builder can, for example, connect to legacy, on-premises, and SaaS systems to create streamlined user workflows via microapp actions. The resource management services 502, and in particular the data integration provider service 532, can, for example, support REST API, JSON, OData-JSON, and 6ML. As explained in more detail below, the data integration provider service 532 can also write back to the systems of record, for example, using OAuth2 or a service account.

In some examples, the microapp service 530 can be a single-tenant service responsible for creating the microapps. The microapp service 530 can send raw events, pulled from the systems of record 528, to the analytics service 538 for processing. The microapp service can, for example, periodically pull active data from the systems of record 528.

In some examples, the active data cache service 536 can be single-tenant and can store all configuration information and microapp data. It can, for example, utilize a pertinent database encryption key and per-tenant database credentials.

In some examples, the credential wallet service 534 can store encrypted service credentials for the systems of record 528 and user OAuth2 tokens.

In some examples, the data integration provider service 532 can interact with the systems of record 528 to decrypt end-user credentials and write back actions to the systems of record 528 under the identity of the end-user. The write-back actions can, for example, utilize a user's actual account to ensure all actions performed are compliant with data policies of the application or other resource being interacted with.

In some examples, the analytics service 538 can process the raw events received from the microapps service 530 to create targeted scored notifications and send such notifications to the notification service 540.

Finally, in some examples, the notification service 540 can process any notifications it receives from the analytics service 538. In some implementations, the notification service 540 can store the notifications in a database to be later served in a notification feed. In other implementations, the notification service 540 can additionally or alternatively send the notifications out immediately to the client 302 as a push notification to the user 526.

In some implementations, a process for synchronizing with the systems of record 528 and generating notifications can operate as follows. The microapp service 530 can retrieve encrypted service account credentials for the systems of record 528 from the credential wallet service 534 and request a sync with the data integration provider service 532. The data integration provider service 532 can then decrypt the service account credentials and use those credentials to retrieve data from the systems of record 528. The data integration provider service 532 can then stream the retrieved data to the microapp service 530. The microapp service 530 can store the received systems of record data in the active data cache service 536 and also send raw events to the analytics service 538. The analytics service 538 can create targeted scored notifications and send such notifications to the notification service 540. The notification service 540 can store the notifications in a database to be later served in a notification feed and/or can send the notifications out immediately to the client 302 as a push notification to the user 526.

In some implementations, a process for processing a user-initiated action via a microapp can operate as follows. The client 302 can receive data from the microapp service 530 (via the client interface service 516) to render information corresponding to the microapp. The microapp service 530 can receive data from the active data cache service 536 to support that rendering. The user 526 can invoke an action from the microapp, causing the resource access application 524 to send that action to the microapp service 530 (via the client interface service 516). The microapp service 530 can then retrieve from the credential wallet service 534 an encrypted Oauth2 token for the system of record for which the action is to be invoked and can send the action to the data integration provider service 532 together with the encrypted Oauth2 token. The data integration provider service 532 can then decrypt the Oauth2 token and write the action to the appropriate system of record under the identity of the user 526. The data integration provider service 532 can then read back changed data from the written-to system of record and send that changed data to the microapp service 530. The microapp service 532 can then update the active data cache service 536 with the updated data and cause a message to be sent to the resource access application 524 (via the client interface service 516) notifying the user 526 that the action was successfully completed.

### Contact Recommendation Process

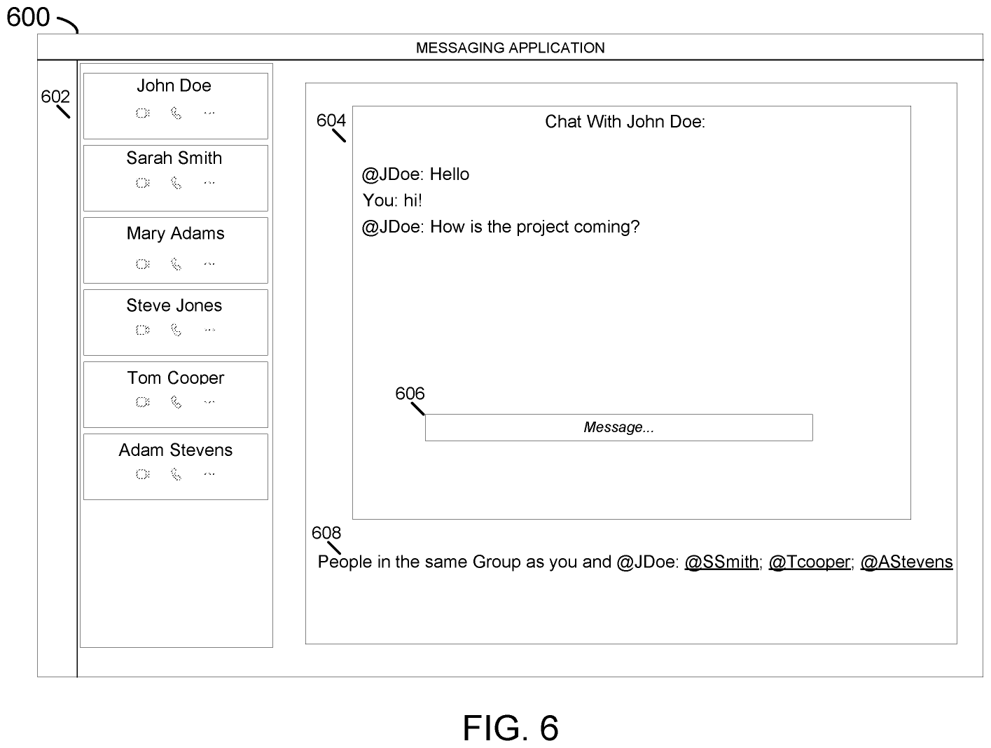

User communication sessions can be implemented via one or more messaging applications implemented using a messaging interface such as messaging interface 106 as shown in FIG. 1. The interface can be implemented as a user accessible control in, for example, a distributed workspace application. For example, FIG. 6 illustrates a sample view of a user interface screen 600 that is displayed on a client computing device such as computing device 102 as shown in FIG. 1 and described above, and displayed by a workspace application such as, for example, workspace application 104.

As illustrated in FIG. 6, the screen 600 includes user interface controls 602, 604, 606, and 608. In the example as shown in FIG. 6, each of the user interface controls 602, 604, 606, and 608 is associated with a particular feature within the messaging application. For example, user interface control 602 represents a contact list of the user of the messaging application. In certain implementations, the contact list can include user-selected contacts such as friends of close coworkers as well as members of a group or team to which the user of the messaging application also belongs. For example, a group of contacts can include people that all share the same supervisor, are all assigned to the same task, all work in the same physical office, or share another common trait. The messaging application can retrieve this information from a directory service such as, for example, the identity service 518 as described above. The identity service 518 can access the identify provider 512 to access a directory service to determine group information for one or more users and associated contacts as described herein.

As further shown in FIG. 6, user interface control 604 can include a chat window. In the example shown in FIG. 6, the user of the messaging application is engaged in a messaging session with John Doe. The user interface control 604 further includes an additional user interface control 606 that the user of the messaging application can use to type and submit an additional message to John Doe within the overall messaging session as included in user interface control 604.

The messaging application can further include user interface control 608 that includes a set of recommendations for the user of the messaging application. As shown in FIG. 6, the recommendation of additional contacts is limited to other people in the same group as the user of the messaging application and John Doe. As such, the current contact recommendations are generally limited in scope. However, as described herein below, historical group messaging information can be used to generate more useful contact recommendations for a user of a messaging application.

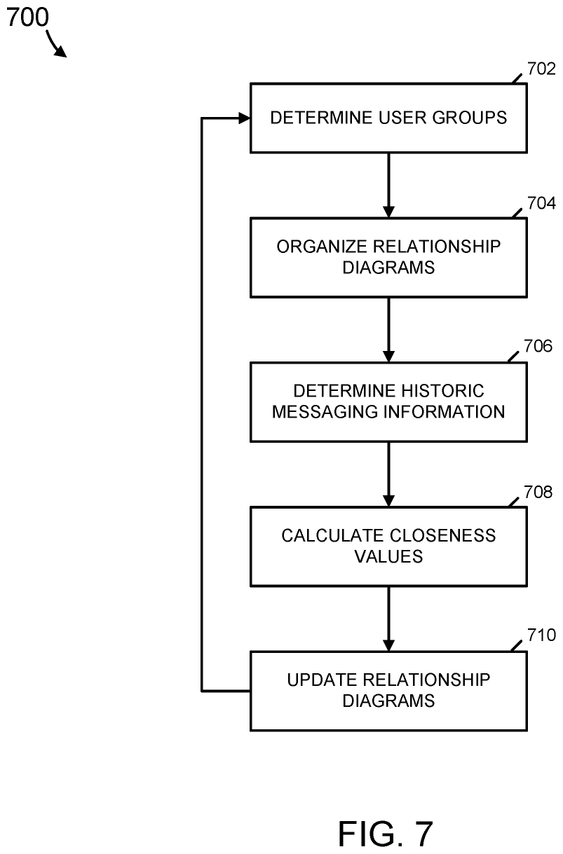

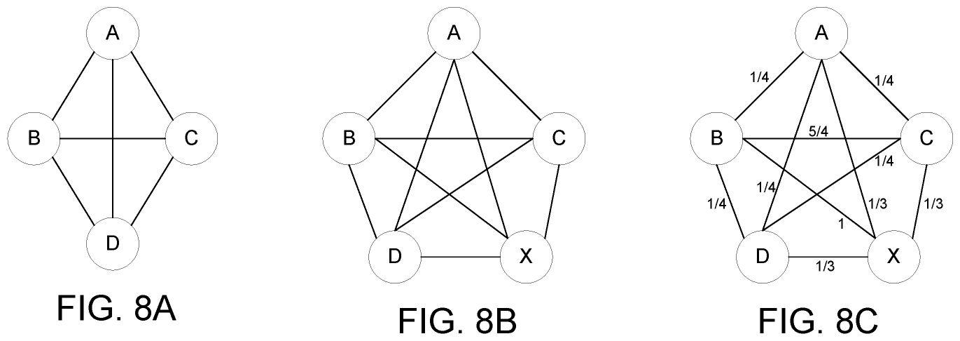

FIG. 7 illustrates a sample process 700 for generating contact relationship diagrams including associated closeness values as described herein. A contact relationship diagram, as referred to herein, is a data structure that quantifies one or more closeness values representing, for example, how often particular contacts interact. The contact relationship diagrams can be updated regularly based upon updated historical messaging application information. Examples of contact relationship diagrams are provided in FIGS. 8A-8C, 9A-9C, and 10A-10C, and are described below in additional detail.

The process 700 as shown in FIG. 7 can be implemented, for example, by a processor of a computing device such as the workspace host device 110 and/or the messaging application system 116 as shown in FIG. 1.

As shown in FIG. 7, the processor can determine 702 one or more user groups for users of a messaging application. For example, the processor can determine 702 the one or more user groups based upon company organizational information as stored within a directory service administered by the organization. For example, a group can include all employees with the same manager, all employees assigned to the same project team, all employees located in the same physical office, all employees on the same hierarchal level in the organization (e.g., all regional managers), and other similar sets of people that share one or more work-related traits. In some examples, a group can be created and maintained by one or more users of the messaging application. Members in the group can be determined via invitation or by maintaining a group record of members. The messaging application can include group maintenance and monitoring features that can provide the processor additional information when determining 702 the one or more groups as described herein.

As further shown in FIG. 7, the processor can organize 704 members of the one or more groups into one or more relationship diagrams. For example, as described herein, each of the determined 702 groups can include a unique relationship diagram. The relationship diagram can be represented as a data structure that includes at least one link between each member of the group. Each link can have an associated closeness value (“CV”). As described herein, a closeness value can be representative of how likely a person is to mention another person in a conversation. The higher the associated closeness value for a particular link in a relationship diagram, the more likely a person is to mention the linked person. A relationship diagram can also include additional users or contacts that are outside of the group but that may have been mentioned in a conversation between group members. Additional information and examples of groups and relationship diagrams is provided in the discussion of FIGS. 8A-10C below.

The processor can further determine 706 historic messaging information for members of the group based upon, for example, past messaging sessions between the members of the group. For example, the processor can call a messaging record API to obtain the historic data for historic messaging conversations. For example, when using the messaging application Slack, the processor can call the conversations.list API to obtain all channels for a particular user in one or more messaging groups. Once the conversations.list API has been called, the processor can further call, for example, the conversations.history API to obtain historical information for each of the user's previous calls. Based upon this set of information, the processor can determine historic information including which members of a particular group were participating in an individual messaging session, how often each individual member of the group was referenced by name during the messaging session, whether any people outside the group were mentioned during the messaging session, and other similar historical information.

To determine name usage, the processor can be configured to parse the text of a messaging session to identify character strings that represent a user's name. In some examples, participants in the messaging session can append one or more marking characters to a user's name for identification. For example, a user can include an “@” sign or a “#” sign before a username to indicate the following text refers to a username.

Referring again to FIG. 7, the processor can further calculate 708 one or more closeness values for each group member and any additional people mentioned during a messaging session based upon the historical information. The processor can then update 710 each of the one or more relationship diagrams to include the closeness values. As further shown in FIG. 7, the process 700 can repeat such that the processor continues to determine updated user groups and related relationship diagrams based upon updated messaging session information.

As noted above, to provide customized contact recommendations for a particular user, a processor can organize, update, and maintain a set of relationship diagrams including calculated contact values. FIGS. 8A-8C illustrate a sample progression of a relationship diagram from determining user groups (e.g., step 702 as shown in FIG. 7 and described above), to organizing initial relationship diagrams (e.g., step 704 as shown in FIG. 7 and described above), to updating the initial relationship diagrams to include closeness values (e.g., step 710 as shown in FIG. 7 and described above).

FIG. 8A illustrates a relationship diagram for a group of contacts using a messaging application as described herein. For example, as shown in FIG. 8A, the group can include four members: A, B, C, and D. As noted above, the group can be defined or organized using, for example, an organizational data structure that defines one or more characteristics for each member of the group. Based upon these characteristics, users with common or shared characteristics such as a shared manager can be organized into one or more groups. As further shown in FIG. 8A, each member of the group can be connected to each other member of the group, represented in the figure by the lines connecting each circle representing an individual group member (i.e., circles A, B, C, and D).

As noted above, the processor can analyze historic messaging or chat information for a group to determine if any additional users were identified during that messaging session. For example, during a messaging session between users A, B, C, and D, one of the users may mention user X during the conversation. In such an example, user X can be added to the corresponding relationship diagram for that group conversation. For example, as shown in FIG. 8B, user X has been added to the relationship diagram that previously included group members A, B, C, and D.

The processor can further determine a closeness value for each contact within the relationship diagram. For example, the processor can set a default closeness value for each connection between members of the group. As shown in FIG. 8A, the group includes four members. The process can set variable n equal to four. In such an example, the default closeness value between each group member can be set to 1/n or, in this example, ¼. As such, in this examples, CV_{AB}=¼, CV_{AC}=¼, CV_{AD}=¼, CV_{BC}=¼, CV_{BD}=¼, and CV_{CB}=¼.

Additionally, for each time that a member of the group mentions another member of the group during a messaging session, the closeness value can be incremented by a set value. For example, each time that a group member mentions another member the closeness value can be incremented by one. For example, if one assumes that member B mentions member C one time during the group messaging session, the closeness value CV_{BC} can be incremented by 1. In such an example, the updated closeness value CV_{BC} can now equal 5/4.

Additionally, the processor can further determine closeness values for each member of the group and the contact X. If one assumes that member B mentioned contact X during the messaging session, the closeness value CV_{BX} can be set to one. For each other member of the group, the closeness value between that member and contact X can be set to 1/(n−1). As such, the closeness values for each member of the group and contact X can be set as: CV_{AX}=⅓, CV_{BX}=1, CV_{CX}=⅓, and CV_{BX}=⅓.

FIG. 8C illustrates a relationship diagram including each of the closeness values as defined above. For example, as shown in FIG. 8C, the closeness values are set as: CV_{AB}=¼, CV_{AS}=¼, CV_{RD}=¼, CV_{AX}=⅓, CV_{BC}= 5/4, CV_{BD}=¼, CV_{BX}=1, CV_{CD}=¼, CV_{CX}=⅓, and CV_{DX}=⅓.

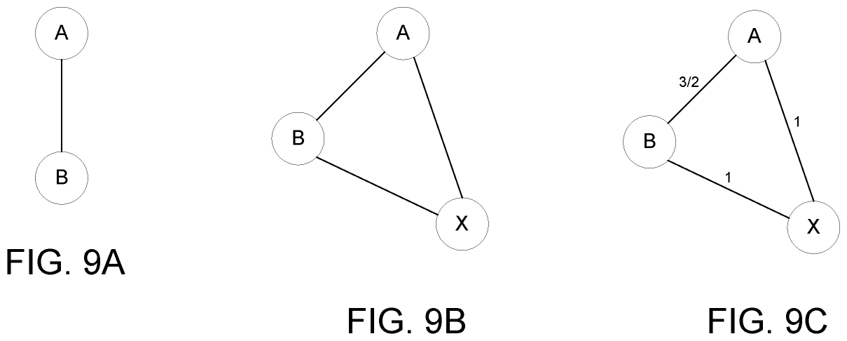

The process 700 as shown in FIG. 7 and described above, and the resulting relationship diagrams as shown in FIGS. 8A-8C, can be repeated for multiple groups of members. For example, FIGS. 9A-9C illustrate a sample progression of a relationship diagram for a group of members including members A and B. As shown in FIG. 9A, the group includes members A and B and a single connection is shown between the two members. As shown in FIG. 9B, during review of historical messaging session information between A and B, the processor can identify a reference to contact X. As such, the initial relationship diagram as shown in FIG. 9B can be updated to show non-member contact X.

As described above, the processor can further determine closeness values for members A and B as well as contact X. In this example, n=two (i.e., two group members). As such, the default closeness values between A and B can be set to 1/n or, in this example, ½. As such, the closeness value CV_{AB}=½.

During the messaging session, one can assume that member B mentioned member A by name. As such, the closeness value CV_{AB} can be incremented by 1. In such an example, the updated closeness value CV_{AB} can now equal 3/2. Additionally, one can assume that member B again mentioned contact X during a messaging session with member A. In such an example, the closeness value CV_{BX} can be set to one. For each other member of the group, the closeness value between that member and contact X can be set to 1/(n−1). As such, the closeness value for member A can be set to CV_{AX}=1/(2−1) or simply 1.

FIG. 9C illustrates a relationship diagram including each of the closeness values as defined above. For example, as shown in FIG. 9C, the closeness values are set as: CV_{AB}=3/2, CV_{AX}=1, and CV_{BX}=1.

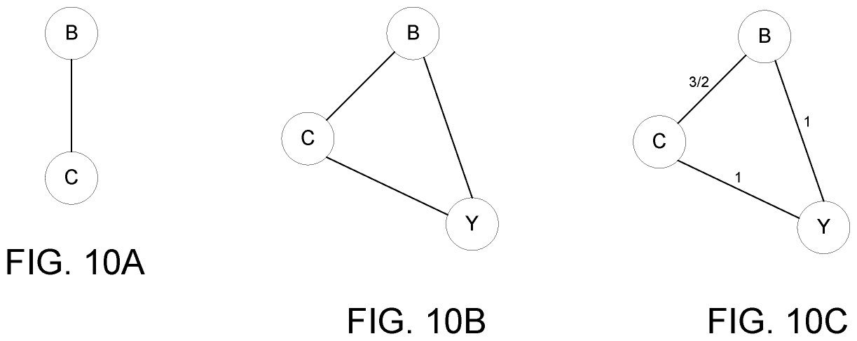

In another example, FIGS. 10A-10C illustrate a sample progression of a relationship diagram for a group of members including members B and C. As shown in FIG. 10A, the group includes members B and C and a single connection is shown between the two members. As shown in FIG. 10B, during review of historical messaging session information between B and C, the processor can identify a reference to contact Y. As such, the initial relationship diagram as shown in FIG. 10B can be updated to show non-member contact Y.

As described above, the processor can further determine closeness values for members B and C as well as contact Y. In this example, n=two (i.e., two group members). As such, the default closeness values between B and C can be set to 1/n or, in this example, ½. As such, the closeness value CV_{BC}=½.

During the messaging session, one can assume that member B mentioned member C by name. As such, the closeness value CV_{BC} can be incremented by 1. In such an example, the updated closeness value CV_{BC} can now equal 3/2. Additionally, one can assume that member B mentioned contact Y during a messaging session with member C. In such an example, the closeness value CV_{BY} can be set to one. For each other member of the group, the closeness value between that member and contact X can be set to 1/(n−1). As such, the closeness value for member C can be set to CV_{CY}=1/(2−1) or simply 1.

FIG. 10C illustrates a relationship diagram including each of the closeness values as defined above. For example, as shown in FIG. 10C, the closeness values are set as: CV_{BCB}=3/2, CV_{BY}=1, and CV_{CY}=1.

As such, a formula can be developed for determining the closeness value between individual contacts in an organization. If the contacts are in the same group (e.g., as retrieved from a directory service as described herein), the initial closeness values can be set to 1/n where n is the number of members in the group (assuming that n is greater than or equal to two). For each time one of a pair of contacts mentions the other contact in a group messaging session, the closeness value of the pair can be increased by one.

The formula can further include determining the closeness value for a pair of contacts when the pair are not members of the same group. Initially, the closeness value between the two contacts can be set to zero. When a member of the group that one of the contacts belongs to mentions the other (non-member) contact, the closeness values can be incremented. For example, if a group member directed references the username or otherwise identifies a non-group member, the closeness value between that group member and the non-group member can be incremented by one. For each other member in the group (that has not referenced the non-group member), the closeness value between that member and the non-group member can be incremented by 1/(n−1).

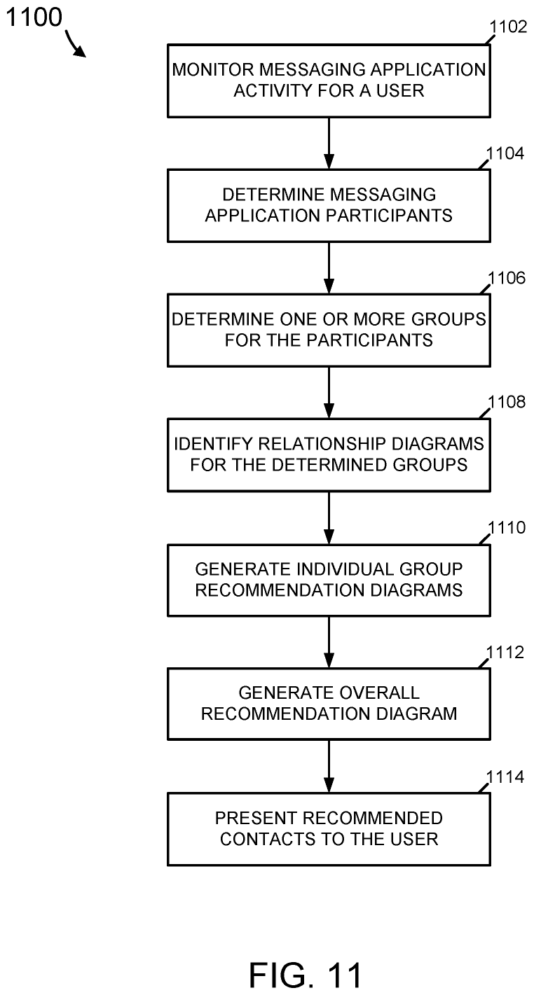

Once the relationship diagrams with associated closeness values have been determined (e.g., the relationship diagrams as shown in FIGS. 8C, 9C, and 10C), the processor can determine one or more recommended contacts to provide to a user during a messaging session. For example, FIG. 11 illustrates process 1100 for determining one or more recommended contacts. The process 1100 as shown in FIG. 11 can be implemented, for example, by a processor of a computing device such as the workspace host device 110 and/or the messaging application system 116 as shown in FIG. 1.

As shown in FIG. 11, the processor can monitor 1102 messaging application for activity by each user that is registered to use the messaging application. Once the processor has determined that a user has established a messaging session, the processor can further determine 1104 which users are participating in the messaging session. For example, the processor can determine that users A and B are participating in the messaging session.

As further shown in FIG. 11, the processor can determine 1106 one or more groups that both users A and B belong to. For example, as shown above, both users A and B belong to the group (e.g., group 1) represented by the relationship diagrams as shown in FIGS. 8A-8C as well as the group (e.g., group 2) represented by the relationship diagrams as shown in FIGS. 9A-9C. As such, the processor can identify 1108 one or more relationship diagrams for the determined groups. In this example, the processor can identify 1108 the relationship diagram as shown in FIG. 8C and the relationship diagram as shown in FIG. 9C. As the set of relationship diagrams shown in FIGS. 10A-10C do not include both users A and B, the processor can exclude the relationship diagrams shown in those figures when determining recommended contacts for user A.

As further shown in FIG. 11, the processor can generate 1110 individual group recommendation diagrams for each group that includes both A and B. To generate 1110 the individual group recommendation diagrams, the processor can take the final recommendation diagrams for each group, including the determined closeness values (e.g., FIGS. 8C and 9C), and restructure the relationship diagrams to remove user A (and all associated closeness values) from the relationship diagrams. The processor can also remove all closeness values and connection for all contacts that are not active participants in the current messaging session. In this example, the processor would remove all closeness values for all combinations of users except those including user B.

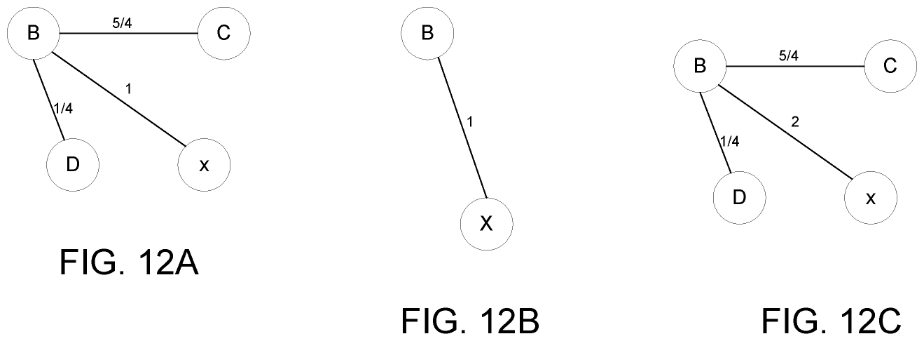

For example, FIG. 12A illustrates an individual group recommendation diagram for group 1, based upon the final relationship diagram as shown in FIG. 8C. As shown in FIG. 12A, user A has been removed entirely from the diagram, and only the closeness values associated with user B have been maintained. Thus, as shown in FIG. 12A, the maintained closeness values are: CV_{BC1}=5/4, CV_{BD1}=¼, and CV_{BX1}=1.

Similarly, FIG. 12B illustrates an individual group recommendation diagram for group 2, based upon the final relationship diagram as shown in FIG. 9C. As shown in FIG. 12B, user A has been removed entirely from the diagram, and only the closeness values associated with user B have been maintained. Thus, as shown in FIG. 12B, the maintained closeness value is CV_{BX}2=1.

Referring back to FIG. 11, the processor can generate 1112 an overall recommendation diagram based upon a summation of the individual group recommendation diagrams. To continue the above example, the processor can sum the closeness values as shown in FIG. 12A with the closeness values as shown in FIG. 12B to generate 1112 the overall recommendation diagram. As shown in FIG. 12C, the overall recommendation diagram includes summed or total closeness values CV_{BCT}, CV_{BDT}, and CV_{BXT}. More specifically, CV_{BCT}=CV_{BC1}+CV_{BC}2=5/4+0=5/4, CV_{BDT}=CV_{BD1}+CV_{BD}2=¼+0=¼, and CV_{BXT}=CV_{BX1}+CV_{BX2}=1+1=2. As such, as shown in FIG. 12C, the total closeness values are” CV_{BCT}=5/4, CV_{BDT}=¼, and CV_{BXT}=2.

Referring back to FIG. 11, the processor can process the overall recommendation diagram and present 1114 the recommended contacts to, in this example, user A. For example, the processor can organize the recommended contacts based upon total closeness value organized from highest to lowest. In the above example as illustrated in FIGS. 12A-12C, the processor can recommend contact X first (with a total closeness value of two), followed by contact C (with a total closeness value of 5/4) and then contact D (with a total closeness value of ¼).

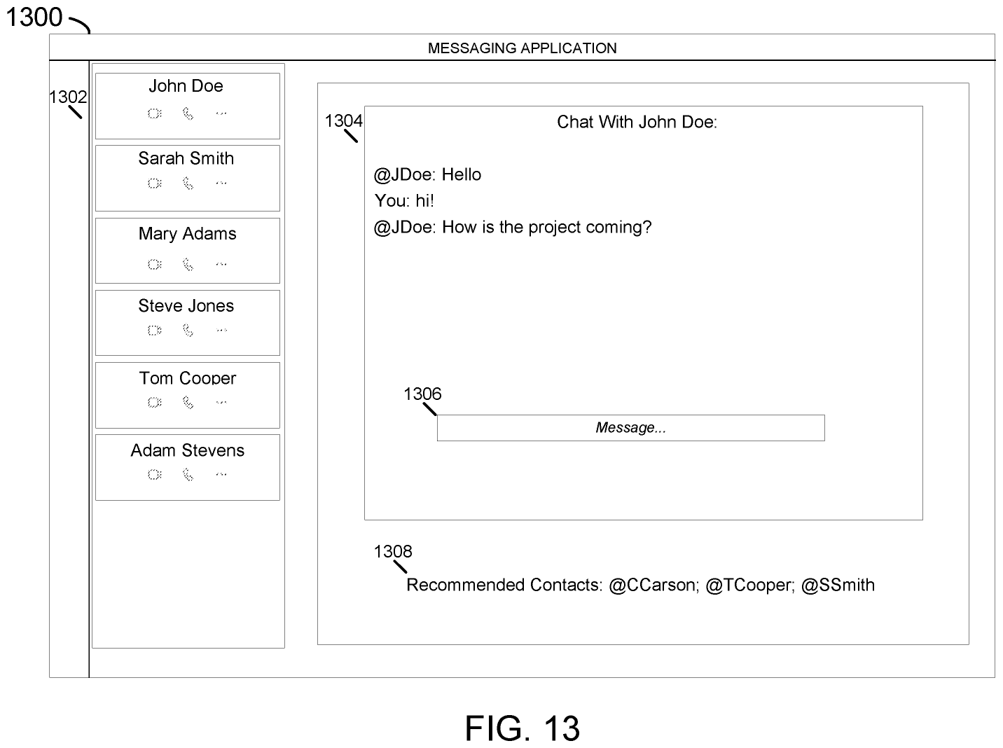

FIG. 13 illustrates a sample view of a user interface screen 1300 that is displayed on a client computing device such as computing device 102 as shown in FIG. 1 and described above, and displayed by a workspace application such as, for example, workspace application 104. Unlike screen 600 as described above, however, the messaging application captured in screen 1300 includes the contact recommendation process as described herein.

As illustrated in FIG. 13, the screen 1300 includes user interface controls 1302, 1304, 1306, and 1308. In the example as shown in FIG. 13, each of the user interface controls 1302, 1304, 1306, and 1308 is associated with a particular feature within the messaging application. For example, user interface control 1302 represents a contact list of the user of the messaging application. In certain implementations, the contact list can include user-selected contacts such as friends of close coworkers as well as members of a group or team to which the user of the messaging application also belongs. For example, a group of contacts can include people that all share the same supervisor, are all assigned to the same task, all work in the same physical office, or share another common trait.

As further shown in FIG. 13, user interface control 1304 can include a chat window. In the example shown in FIG. 13, the user of the messaging application is engaged in a messaging session with John Doe. The user interface control 1304 further includes an additional user interface control 1306 configured to receive input from the user of the messaging application that specifies an additional message to submit to John Doe within the overall messaging session displayed in user interface control 1304.

The messaging application can further include user interface control 1308 configured to display a set of recommended contacts for the user of the messaging application. As shown in FIG. 13, the recommended contacts can include contacts determined, organized, and presented to the user based upon analysis of historical conversations between the user and John Doe as well as conversations between the user, John Doe, and other group members associated with groups to which the user and John Doe both belong to. In such an example, the recommended contacts as shown in user interface 1308 can be generated specifically for the user of the messaging application and based upon analyzed historical messaging data to more accurately recommend a contact to the user that may be beneficial for the user to connect and engage with in a messaging session.

### Hardware Implementation Examples

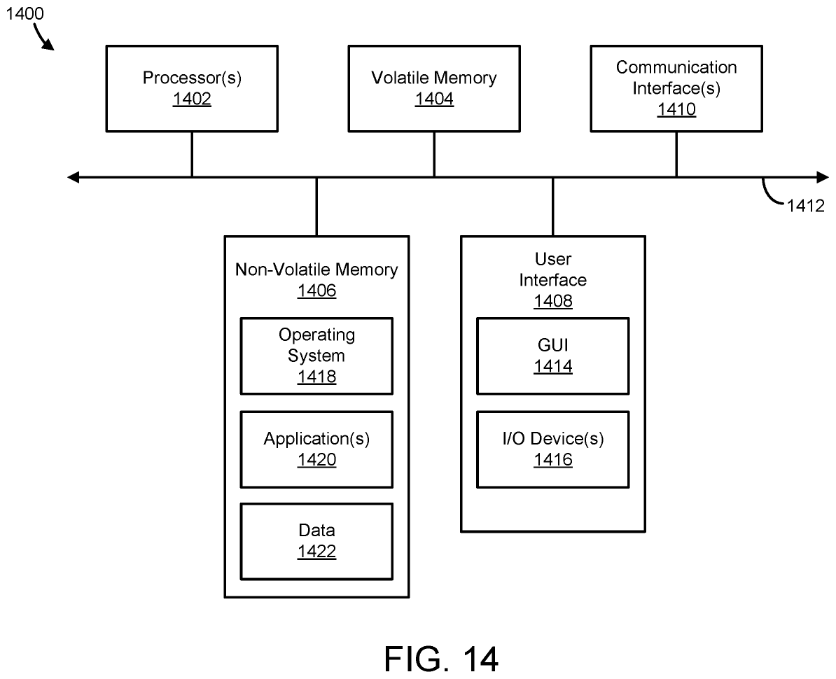

FIG. 14 depicts a block diagram of a computing device 1400 useful for practicing an example of client device 102 and/or workspace host device 110 as shown in FIG. 1 and described above. The computing device 1400 includes one or more processors 1402, volatile memory 1404 (e.g., random access memory (RAM)), non-volatile (non-transitory) memory 1406, UI 1408, one or more communications interfaces 1410, and a communications bus 1412. One or more of the computing devices 1400 can also be referred to as a computer system.

The non-volatile memory 1406 can include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 1408 can include a graphical user interface (GUI) 1414 (e.g., a touchscreen, a display, etc.) and one or more input/output (I/O) devices 1416 (e.g., a mouse, a keyboard, a microphone, one or more speakers, one or more cameras, one or more biometric scanners, one or more environmental sensors, and one or more accelerometers, etc.).

The non-volatile memory 1406 can store an operating system 1418, one or more applications 1420, and data 1422 such that, for example, computer instructions of the operating system 1418 and/or the applications 1420 are executed by processor(s) 1402 out of the volatile memory 1404. In some examples, the volatile memory 1404 can include one or more types of RAM and/or a cache memory that can offer a faster response time than a main memory. Data can be entered using an input device of the GUI 1414 or received from the I/O device(s) 1416. Various elements of the computing device 1400 can communicate via the communications bus 1412.

The illustrated computing device 1400 is shown merely as an example client device or server and can be implemented by any computing or processing environment with any type of machine or set of machines that can have suitable hardware and/or software capable of operating as described herein.

The processor(s) 1402 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values and/or using analog signals.

In some examples, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory.

The processor 1402 can be analog, digital or mixed. In some examples, the processor 1402 can include multiple processor cores and/or multiple processors configured to provide functionality for parallel, simultaneous execution of instructions or for parallel, simultaneous execution of one instruction on more than one piece of data.

The communications interfaces 1410 can include one or more interfaces to enable the computing device 1400 to access a computer network such as a Local Area Network (LAN), a Wide Area Network (WAN), a Personal Area Network (PAN), or the Internet through a variety of wired and/or wireless connections, including cellular connections.

In described examples, the computing device 1400 can execute an application on behalf of a user of a client device (e.g., client device 102 as shown in FIG. 1 and described above). For example, the computing device 1400 can execute one or more virtual machines managed by a hypervisor and accessed via, for example, a client agent. Each virtual machine can provide an execution session within which applications execute on behalf of a user or a client device, such as a hosted desktop session. The computing device 1400 can also execute a terminal services session to provide a distributed workspace environment. The computing device 1400 can provide access to a remote computing environment including one or more applications, one or more desktop applications, and one or more desktop sessions in which one or more applications can execute.

Having thus described several aspects of at least one example, it is to be appreciated that various alterations, modifications, and improvements will readily occur to those skilled in the art. For instance, examples disclosed herein can also be used in other contexts. Such alterations, modifications, and improvements are intended to be part of this disclosure and are intended to be within the scope of the examples discussed herein. Accordingly, the foregoing description and drawings are by way of example only.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

1. A computing device configured to provide personal contact recommendations to a user of a messaging application, the computing device comprising:
a memory;
a user interface; and
at least one processor coupled to the memory and the user interface and configured to:
monitor interactions between the user and the messaging application during a messaging session,
determine one or more additional participants in the messaging session,
determine a plurality of closeness values based upon the user and the one or more additional participants in the messaging session, the plurality of closeness values representing a frequency of interactions between the one or more additional participants and contacts of the one or more additional participants,
select, from the contacts of the one or more additional participants, one or more recommended contacts for the user based upon the plurality of closeness values, and
display, on the user interface, an identifier of at least one of the one or more recommended contacts to the user during the messaging session for updating a contact list of the user.

2. The computing device of claim 1, wherein the at least one processor being configured to determine the plurality of closeness values comprises the at least one processor being further configured to:
determine one or more user groups to which the user and the one or more additional participants belong; and
identify one or more relationship data structures associated with the one or more user groups, the one or more relationship data structures comprising a structured listing of the contacts of the one or more additional participants and a plurality of links, each link of the plurality of links being between a pair that includes one of the contacts and one of the one or more additional participants, and each link having an associated closeness value of the plurality of closeness values, the associated closeness value representing the frequency of interactions between the pair.

3. The computing device of claim 2, wherein the one or more relationship data structures comprises a plurality of relationship diagrams, and the at least one processor is further configured to:
identify two or more relationship data structures within the plurality of relationship diagrams that correspond to the user and the one or more additional participants;
identify a plurality of corresponding closeness values within the two or more relationship data structures;
calculate a set of total closeness values for each pair of contacts within the two or more relationship data structures by summing the identified plurality of corresponding closeness values; and
generate an overall recommendation diagram based upon the set of total closeness values.

4. The computing device of claim 3, wherein the at least one processor is further configured to determine the one or more recommended contacts for the user based upon the overall recommendation diagram.

5. The computing device of claim 2, wherein at least one of the one or more recommended contacts for the user is not a member of the one or more user groups.

6. The computing device of claim 1, wherein the at least one processor is further configured to:
determine one or more user groups of which the user is a member;
determine historic messaging session information for each of the one or more user groups; and
determine a plurality of historic closeness values based upon the historic messaging session information.

7. The computing device of claim 6, wherein the at least one processor is further configured to:
monitor for changes to the one or more user groups and/or the historic messaging session information; and
update the plurality of historic closeness values based upon changes to the one or more user groups and/or the historic messaging session information.

8. The computing device of claim 6, wherein the at least one processor is further configured to:
determine when a first member of the one or more user groups mentions a name of a second contact in the historic messaging session information; and
increment a closeness value between the first member and the second contact based upon the determined mention.

9. The computing device of claim 8, wherein the second contact is not a member of the one or more user groups.

10. A method for providing personal contact recommendations to a user of a messaging application, the method comprising:
monitoring, by at least one processor, interactions between the user and the messaging application during a messaging session;
determining, by the at least one processor, one or more additional participants in the messaging session;
determining, by the at least one processor, a plurality of closeness values based upon the user and the one or more additional participants in the messaging session, the plurality of closeness values representing a frequency of interactions between the one or more additional participants and contacts of the one or more additional participants;
selecting, by the at least one processor, from the contacts of the one or more additional participants, one or more recommended contacts for the user based upon the plurality of closeness values; and
displaying, by the at least one processor on a user interface, an identifier of at least one of the one or more recommended contacts to the user during the messaging session for updating a contact list of the user.

11. The method of claim 10, wherein determining the plurality of closeness values comprises:
determining, by the at least one processor, one or more user groups to which the user and the one or more additional participants belong; and
identifying, by the at least one processor, one or more relationship data structures for associated with the one or more user groups, the one or more relationship data structures comprising a structured listing of the contacts of the one or more additional participants and a plurality of links, each link of the plurality of links being between a pair that includes one of the contacts and one of the one or more additional participants, and each link having an associated closeness value of the plurality of closeness values, the associated closeness value representing the frequency of interactions between the pair.

12. The method of claim 11, wherein the one or more relationship data structures comprises a plurality of relationship diagrams, and the method further comprises:
identifying, by the at least one processor, two or more relationship data structures within the plurality of relationship diagrams that correspond to the user and the one or more additional participants;
identifying, by the at least one processor, a plurality of corresponding closeness values within the two or more relationship data structures;
calculating, by the at least one processor, a set of total closeness values for each pair of contacts within the two or more relationship data structures by summing the identified plurality of corresponding closeness values; and
generating, by the at least one processor, an overall recommendation diagram based upon the set of total closeness values.

13. The method of claim 12, further comprising determining, by the at least one processor, the one or more recommended contacts for the user based upon the overall recommendation diagram.

14. The method of claim 11, wherein at least one of the one or more recommended contacts for the user is not a member of the one or more user groups.

15. The method of claim 10, further comprising:
determining, by the at least one processor, one or more user groups to which the user is a member;
determining, by the at least one processor, historic messaging session information for each of the one or more user groups; and
determining, by the at least one processor, a plurality of historic closeness values based upon the historic messaging session information.

16. The method of claim 15, further comprising:
monitoring, by the at least one processor, for changes to the one or more user groups and/or the historic messaging session information; and
updating, by the at least one processor, the plurality of historic closeness values based upon changes to the one or more user groups and/or the historic messaging session information.

17. The method of claim 15, further comprising:
determining, by the at least one processor, when a first member of the one or more user groups mentions a name of a second contact in the historic messaging session information; and
incrementing, by the at least one processor, a closeness value between the first member and the second contact based upon the determined mention.

18. The method of claim 17, wherein the second contact is not a member of the one or more user groups.

19. A non-transitory computer-readable medium storing computer-executable instructions to provide personal contact recommendations to a user of a messaging application, the instructions comprising instructions to:
monitor interactions between the user and the messaging application during a messaging session;
determine one or more additional participants in the messaging session;
determine a plurality of closeness values based upon the user and the one or more additional participants in the messaging session, the plurality of closeness values representing a frequency of interactions between the one or more additional participants and contacts of the one or more additional participants;
select, from the contacts of the one or more additional participants, one or more recommended contacts for the user based upon the plurality of closeness values; and
display, on a user interface operably coupled to the non-transitory computer readable medium, an identifier of at least one of the one or more recommended contacts to the user during the messaging session for updating a contact list of the user.

20. The non-transitory computer-readable medium of claim 19, further comprising instructions to:
determine one or more user groups to which the user and the one or more additional participants belong; and
identify one or more relationship data structures associated with the one or more user groups, the one or more relationship data structures comprising a structured listing of the contacts of the one or more additional participants and a plurality of links, each link of the plurality of links being between a pair that includes one of the contacts and one of the one or more additional participants, and each link having an associated closeness value of the plurality of closeness values, the associated closeness value representing the frequency of interactions between the pair.

21. The non-transitory computer-readable medium of claim 20, wherein the one or more relationship data structures comprises a plurality of relationship diagrams, and the instructions further comprise instructions to:
identify two or more relationship data structures within the plurality of relationship diagrams that correspond to the user and the one or more additional participants;
identify a plurality of corresponding closeness values within the two or more relationship data structures;
calculate a set of total closeness values for each pair of contacts within the two or more relationship data structures by summing the identified plurality of corresponding closeness values; and
generate an overall recommendation diagram based upon the set of total closeness values.

22. The non-transitory computer-readable medium of claim 21, further comprising instructions to determine the one or more recommended contacts for the user based upon the overall recommendation diagram.

23. The non-transitory computer-readable medium of claim 20, wherein at least one of the one or more recommended contacts for the user is not a member of the one or more user groups.

24. The non-transitory computer-readable medium of claim 19, further comprising instructions to:
determine one or more user groups to which the user is a member;
determine historic messaging session information for each of the one or more user groups; and
determine a plurality of historic closeness values based upon the historic messaging session information.

25. The non-transitory computer-readable medium of claim 24, further comprising instructions to:
monitor for changes to the one or more user groups and/or the historic messaging session information; and
update the plurality of historic closeness values based upon changes to the one or more user groups and/or the historic messaging session information.

26. The non-transitory computer-readable medium of claim 24, further comprising instructions to:
determine when a first member of the one or more user groups mentions a name of a second contact in the historic messaging session information; and
increment a closeness value between the first member and the second contact based upon the determined mention.

27. The non-transitory computer-readable medium of claim 26, wherein the second contact is not a member of the one or more user groups.
